(19) United States
(12) Patent Application Publication
(10) Pub. No.: US 2025/0383032 A1
(43) Pub. Date: Dec. 18, 2025

(54) FUEL VALVE FOR METERED DELIVERY OF FUEL

(71) Applicant: Robert Bosch GmbH, Stuttgart (DE)

(72) Inventors: Walter Walkner, Hallein (AT); Christian Graspeuntner, Hallein (AT); Martin Rainer, Puch bei Hallein (AT)

(21) Appl. No.: 18/877,455

(22) PCT Filed: Jun. 14, 2023
(86) PCT No.: PCT/EP2023/065895

§ 371 Date: Dec. 20, 2024

(30) Foreign Application Priority Data
Jun. 22, 2022 (DE) 10 2022 206 220.5

(51) Int. Cl. F16K 41/10; F16K 1/36

(52) U.S. Cl. CPC F16K 41/10; F16K 1/36

(57) ABSTRACT

A fuel valve for metered delivery of fuel, having a housing (1) that can be filled with a fluid fuel and having an outlet opening (7). A valve needle (15) is disposed in the housing (1) and can be moved in its longitudinal direction and interacts with a valve seat (17) to open and close the outlet opening (7), wherein the valve needle (15) is surrounded by a crimping bellows (30) over a part of its length, sealing an internal space (32). The crimping bellows (30) is connected in a fluid-tight manner to a connecting ring (40) at the end facing the outlet opening (7) and tensioned by a tensioning nut (23) surrounding the valve needle (15) against a sealing seat (41) on the valve needle (15).

### BACKGROUND

The invention relates to a fuel valve as used for metered delivery of fuel, in particular gaseous fuel.

Valves for metered delivery of gaseous or liquid fuel are, for instance, used to meter fuel into a combustion chamber or intake tract of an engine. It is essential that the right amount of fuel is introduced at the right time to ensure optimum combustion of the fuel in the combustion chamber. Such a fuel valve is known, for example, from DE 10 2021 200 689 A1 and comprises a piston-shaped valve element that is moved by an electromagnet and thereby opens and closes a dosing port. The gaseous fuel in this case flows around the valve element and thus reaches the dosing port. The valve element itself is fitted in one or more sections within the housing, wherein a lubricant is used to ensure fault-free function, coating the guide surfaces of the valve element and thus ensuring that the valve element is able to move.

In order to avoid mixing the lubricant with the fuel, the valve element is located in a lubrication area, which is sealed, among other things, by a crimping bellows, which prevents the mixture of fuel and lubricant but still allows longitudinal movement of the valve element. The crimping bellows is connected to the valve element at its two ends via fluid-tight weld joints, such that the lubricant compartment is hermetically sealed against the fuel.

Manufacturing these weld joints is, on the one hand, complex and requires special equipment for implementation in series production. Moreover, assembly of the valve element is difficult, as it typically consists of multiple parts and the crimping bellows must not be subjected to torsional loads. This makes manufacturing the valve element with welded crimping bellows complex and expensive.

### SUMMARY

The fuel valve according to the invention has the advantage that it is simple, and it therefore possible in a flexible range of ways to seal a lubricant compartment or an interior space surrounding the valve element against an outer space in which the fuel to be metered is routed. For this purpose, the fuel valve for metered delivery of fuel comprises a housing can be billed with a fluid fuel and that has an outlet opening. A valve needle is disposed in the housing that can be moved in its longitudinal direction and that interacts with a valve seat for opening and closing the outlet opening, wherein the valve needle is surrounded by a crimping bellows for a portion of its length that seals an internal space. The crimping bellows has a fluid-tight connection at the end facing the outlet opening to a connecting ring, which is clamped against a sealing seat on the nozzle needle via a clamping nut surrounding the valve needle.

The connecting ring has a fluid-tight connection to the crimping bellows via a welded joint, such that no fluid can leak at this point from the interior of the crimping bellows to the outside. The fluid-tight sealing of the internal space is finally accomplished by tensioning this connecting ring against a sealing seat on the valve needle. Fixation by means of the connecting ring also allows the valve needle to be dismantled again and the crimping bellows to be replaced as needed, providing greater flexibility in the design, as well as in the maintenance and repair of such a fuel valve. A fluid is understood in the context of this patent application to be a gas or a liquid.

In a first advantageous configuration, the clamping nut engages in a thread formed on the outer side of the valve needle. This thread is easy to manufacture and can be placed at various locations on the valve needle depending on the installation situation.

In a further advantageous embodiment, a tensioning sleeve is disposed between the connecting ring and the clamping nut, which also surrounds the valve needle and transfers the pressing force from the clamping nut to the connecting ring. Because of this design, the clamping nut can be disposed at a clear distance from the sealing surface, which allows for additional design freedom.

In a further advantageous configuration, the valve needle forms an outer contour in the area of the tensioning sleeve, which the tensioning sleeve engages in a positive-locking manner so that it is secured against rotation on the valve needle. Thus, the torque of the clamping nut is not transferred to the connecting ring and no further precautions need be taken to prevent a rotation of the connecting ring and thus against any torsion of the crimping bellows.

In a further advantageous embodiment, the sealing seat is conical. This allows for a good seal and self-centering of the connector ring on the valve needle. Advantageously, the abutment surface on the connecting ring is also conical with which the tensioning nut is in contact with the sealing seat.

In a further advantageous embodiment, the sealing surface is configured as a flat ring surface, and a corresponding flat abutment surface is configured on the connecting ring, which also forms a ring surface and with which the connecting ring is in contact with the sealing seat. Such a ring surface is inexpensive to manufacture and can absorb a high pressing force.

In a further advantageous embodiment, a sealing ring is disposed between the connecting ring and the nozzle needle. This sealing ring provides additional sealing and thus increases operational safety. It can also be provided that the sealing ring fulfills the main sealing function, whereas there is only a partial seal between the connecting ring and the sealing seat. In this case, the sealing seat can be any shape, i.e., it can be designed as a flat or tapered seat with any opening angle.

In a further advantageous embodiment, the end of the crimping bellows facing away from the outlet opening is connected to a second connecting ring so as to form a seal. The second connecting ring advantageously abuts a shoulder in the housing facing the outlet opening. This creates a seal between the valve needle and the housing to securely seal the internal space containing the lubricant or other fuel against the fuel.

In a further advantageous embodiment, the internal space is filled with a lubricant. This lubricant may coat various areas in which the valve needle is routed in the housing to ensure a movement with little friction and thus a long service life.

### BRIEF DESCRIPTION OF THE DRAWINGS

The drawing shows various exemplary embodiments of the internal combustion engine according to the invention. The following are shown:

FIG. 1 a longitudinal sectional view through a fuel valve according to the invention, wherein only the essential parts are shown,

FIG. 2 an enlarged illustration in the area of the section of FIG. 1 designated with II,

FIG. 3 a further exemplary embodiment illustrated in the same manner as FIG. 2,

FIG. 4 a further exemplary embodiment of the crimping bellows gasket,

FIG. 5, also another exemplary embodiment of the crimping bellows gasket,

FIG. 5A a cross section view through a valve needle according to the invention in the area of the cross sectional plane designated A in FIG. 5,

FIG. 6 a further exemplary embodiment illustrated in the same manner as FIG. 2, and

FIG. 7 another such exemplary embodiment.

### DETAILED DESCRIPTION

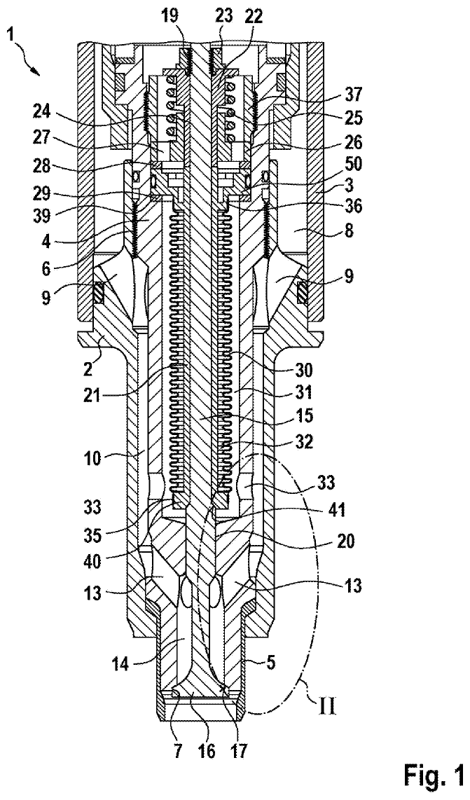

In FIG. 1, a fuel valve according to the invention is shown in a longitudinal section view, wherein only the essential parts are shown. The fuel valve comprises a housing 1 with a valve body 2 and a jacket tube 3 connected to each other in a fluid-tight manner by a tensioning device not shown in more detail in the drawing. A thread 6 is formed inside the valve body 2, into which a nozzle body 4 is screwed, which projects outwardly at the outlet-side end of the valve body 2. The outlet-side end of the nozzle body 4 is surrounded by a valve tube 5, which is fixed between the valve body 2 and the nozzle body 4 by the screw connection on the thread 6. The valve tube 5 is used to form and direct the expelled fuel that exits a nozzle body 4 outlet opening 7 into the valve tube 5, wherein gaseous fuel is preferably metered.

A pressure chamber 8 is formed within the housing 1, which can be filled with the liquid or gaseous fuel to be metered under a nozzle pressure. The pressure chamber 8 is connected to an intermediate space 10 formed between the nozzle body 4 and the valve body 2 and a nozzle space 14 formed in the nozzle body 4, wherein the connections are made via inclined bores 9 in the valve body 2 and via further inclined bores 13 in the nozzle body 4. The fuel in the pressure chamber 8 flows to an outlet opening 7, which is formed at the outlet end of the nozzle body 4.

A piston-shaped valve needle 15 is disposed so that it can be longitudinally displaced inside the nozzle body 4. At its end facing the outlet end of the housing 1, the valve needle 15 comprises a check plate 16 which interacts with a valve seat 17 surrounding the outlet opening 7 to open and close the outlet opening 7. If the valve needle 15 moves towards the outlet opening 7, i.e., downwards in FIG. 1, an annular gap is actuated between the check plate 16 and the valve seat 17 and fuel can flow out of the nozzle space 14, wherein the fuel is directed through the valve tube 5. If the valve needle 15 moves to the valve seat 17 in the system, the outlet opening 7 is closed again.

The nozzle needle 15 extends the entire length of the nozzle body 4 and is guided in a guide section 20 in the nozzle body 4. An annular space 31 is formed between the nozzle needle 15 and the inner wall of the nozzle body 4. The annular space 31 is connected to the intermediate space 10 via connection bores 33 so that it is filled with the fuel to be metered when the fuel valve is in operation. Alternatively, it can also be provided that the fuel flows directly around the crimping bellows 30, for example by designing the inclined bores 9 to open up directly into the annular space 31 and eliminating the intermediate space 10 between nozzle body 4 and valve body 2.

The valve needle 15 is surrounded by a crimping bellows 30, which is disposed inside the nozzle body 4 and with its end facing the outlet opening 7, with a fluid-tight, first welded connection 35 to a connecting ring 40, which is formed integrally with a tensioning sleeve 21 surrounding the valve needle 15. The connecting ring 40 is supported with its outlet opening-side end on a sealing seat 41 of the valve needle 15, while the opposite end of the tensioning sleeve 21 abuts a spring sleeve 22. A thread 19 is formed at the end of the valve needle 15, in which a tensioning nut 23 engages, which tensions the spring sleeve 22 against the tensioning sleeve 21 and thus the connecting ring 40 against the sealing seat 41.

The crimping bellows 30 are connected at the end opposite the first weld joint 35 by a second weld joint 36 to a second connecting ring 50 in a fluid-tight manner, wherein the second connecting ring is tensioned against a shoulder 39 in the nozzle body 4 via a support element 26. To adjust the correct distances, a first adjustment washer 28 is disposed between the second connecting ring 50 and the shoulder 39 formed in the nozzle body 4 and a second adjustment washer 29 is disposed between the support element 26 and the second connecting ring 50. The support element 26 is tensioned via a tensioning screw 37, which engages a thread inside the nozzle body 4. A valve spring 25 is disposed between the support element 26 and the spring sleeve 22 under pre-tension, through which the valve needle 15 is pushed against the valve seat 17. If a sufficiently large longitudinal force is applied to the valve needle 15 by an electrical actuator not shown in the drawing, for example an electromagnet, it moves longitudinally against the force of the valve spring 25 to open the outlet opening 7.

The crimping bellows 30 surrounds an internal chamber 32 that can be filled with a lubricant. The lubricant coats the guide section 24 between the spring sleeve 22 and the support element 26 so that a largely friction-free movement of the valve needle 15 is enabled. A gap remains between the second connecting ring 50 and the tensioning sleeve 21, through which the lubricant can flow. In the area of the support element 26, the flow of lubricant is ensured via through holes 27. The crimping bellows 30 is flexible in the longitudinal direction so that a movement of the valve needle 15 within the housing 1 is not hindered, but nevertheless the internal chamber 32 is sealed against the annular space 31 and thus the lubricant is sealed against the fuel.

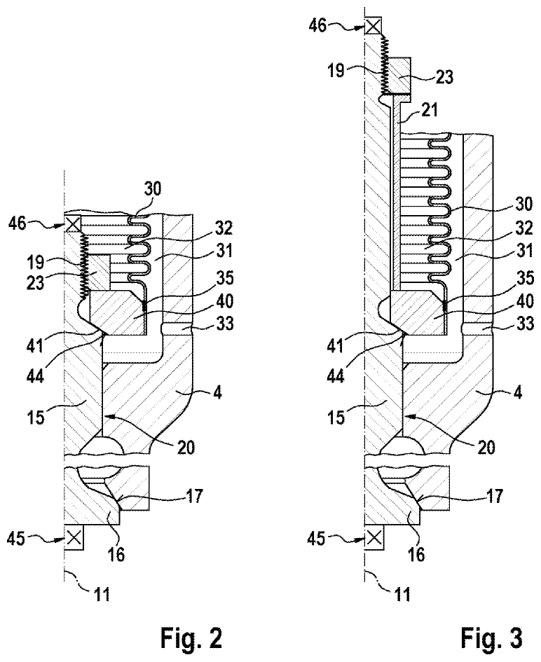

FIG. 2 shows the section of FIG. 1 of a further exemplary embodiment according to the invention designated with II, wherein only half of the fuel valve is shown along the central axis 11. The crimping bellows 30 is connected to a separate connecting ring 40 via its end facing the outlet opening 7. The connecting ring 40 surrounds the valve needle 15 and abuts with a conical abutment surface 44 on a likewise conical sealing seat 41 on the valve needle 15. A fluid-tight weld joint is formed between the crimping bellows 30 and the connecting ring 40. The tensioning nut 23 is disposed within the crimping bellows 30 here and surrounds the valve needle 15. The tensioning nut 23 tensions the connecting ring 40 against the sealing seat 41, wherein it engages the thread 19 on the valve needle 15, which is also disposed here within the crimping bellows 30. Since the tensioning nut 23 abuts the connecting ring 40 directly here, in this exemplary embodiment the tensioning sleeve 21 is omitted. The valve spring 25 not shown here also acts on the valve needle 15 here, but in a different structural manner, so that the spring sleeve 22 is also omitted. A fluid-tight connection is also created by the attachment of the connecting ring 40 to the sealing seat 41 so that the internal chamber 32 bounded by the crimping bellows 30 is sealed and the lubricant therein does not mix with the fuel in the annular space 31. In order for the valve needle 15 to not rotate during tightening of the tensioning nut 23 and thus possibly damage the crimping bellows 30, retaining contours 45, 46 can be provided at the ends of the valve needle 15 in order to retain the valve needle 15 during the screwing process. The retaining contours 45, 46 can be configured in the form of key surfaces, for example.

FIG. 3 shows a further exemplary embodiment of the invention illustrated in the same manner as FIG. 2. The connecting ring 40 is here not pre-tensioned directly against the sealing seat 41 via the tensioning nut 23, but rather as in the exemplary embodiment of FIG. 1 using a tensioning sleeve 21. The tensioning sleeve 21 surrounds the valve needle 15 and transfers the force of the tensioning nut 23 to the connecting ring 40. Thus, the tensioning nut 23 can also be positioned further away from the connecting ring 40, which improves the accessibility of the tensioning nut 23 and facilitates assembly. The tensioning nut 23 can thus also be disposed outside of the crimping bellows 30.

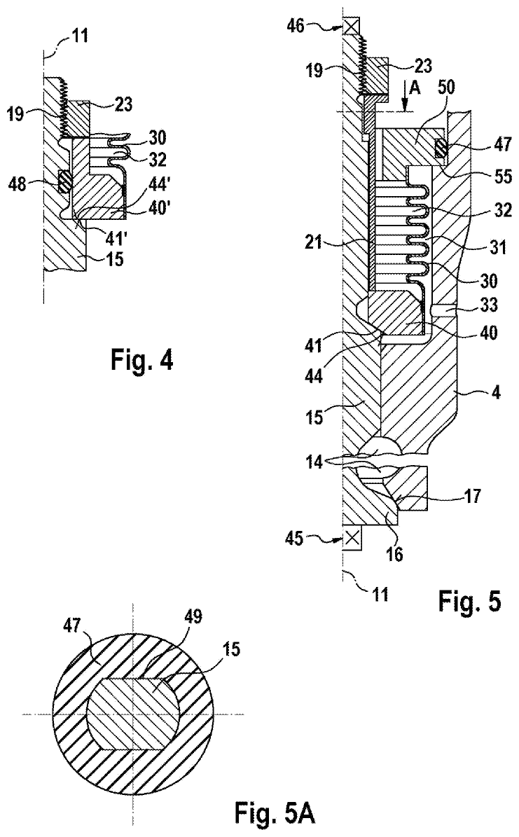

FIG. 4 shows a further exemplary embodiment of the arrangement of the connecting ring 40′ according to the invention. The connecting ring 40′ here has a flat abutment surface 44′, which rests on a likewise flat sealing seat 41′. This configuration of the connecting ring 41 and the abutment surface 44′ is easy to manufacture and allows for horizontal displacement of the connecting ring 40′. An additional sealing ring 48 is provided here between the connecting ring 40 and the valve needle 15 to ensure a secure seal. It may also be contemplated that the actual fluid-tight seal is ensured by the sealing ring 48, while the sealing seat 41′ only serves as abutment of the first connecting ring 40′. This results in more freedom in the configuration of the sealing seat 41′ and the abutment surface 44′, respectively.

A further exemplary embodiment is shown in FIG. 5, illustrated in the same manner as FIG. 3. Here, too, the crimping bellows 30 are connected to the connecting ring 40 in a fluid-tight manner with the end facing the outlet opening 7 via a weld connection 35. A second connecting ring 50 is also present here to seal the opposite end of the crimping bellows 30. The second connecting ring 50 is also connected to the crimping bellows 30 via a weld connection 36 and is located on a shoulder 55 in the nozzle body 4. In addition, a sealing ring 47 is disposed between the second connecting ring 50 and the nozzle body 4 in order to achieve an additional seal of the internal chamber 32 here-similar to the illustration in FIG. 4. The shoulder 55 is flat so that the sealing ring 47 optimizes the sealing. The tensioning force on the connecting ring 40 is also produced here via a tensioning sleeve 21 and a tensioning nut 23. To prevent the tensioning sleeve 21 from rotating when the tensioning nut 23 is screwed on, the valve needle 15 has an outer contour 49 into which the tensioning sleeve 21 engages with a corresponding inner contour. To this end, FIG. 5A shows a cross section through the exemplary embodiment shown in FIG. 5 along line A. Since the tensioning sleeve 21 and the valve needle 15 interlock, the twisting of the tensioning sleeve 21 when screwing the tensioning nut 23 is prevented, in order to prevent a torsion torque from being exerted on the first connecting ring 40. In addition, retaining contours 45, 46 can also be configured on the valve needle 15 in order to fix them when the tensioning nut 23 is screwed on. An interconnected outer and inner contour may also be provided between the connecting ring 40 and the valve needle 15, or between the spring sleeve 22 and the valve needle 15.

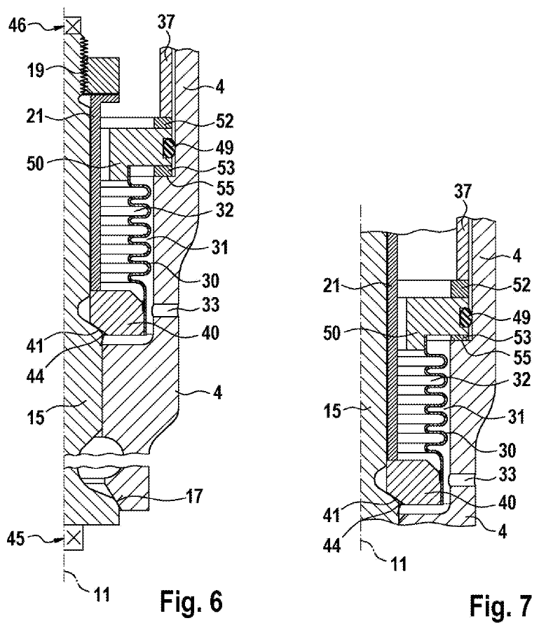

FIG. 6 shows another exemplary embodiment illustrated in the same manner as FIG. 5. Here, too, the second connecting ring 50 is tensioned against the shoulder 55 by the tensioning screw 37, wherein two adjustment washers 52, 53 are used: A first adjustment washer 52 is disposed between the tensioning screw 37 and the second connecting ring 50, and a second adjustment washer 53 is disposed between the second connecting ring 50 and the shoulder 55. The position of the second connecting ring 50 within the nozzle body 4 can thus be precisely adjusted so that a different amount of pre-tensioning of the crimping bellows 30 does not reduce or increase the spring force of the valve spring 25. The first adjustment washer 52 and the second adjustment washer 53 do not need to be of the same thickness as shown in the exemplary embodiment of FIG. 7. Without changing the position of the tensioning screw 37, the first adjustment washer 52 is formed thicker here than the second adjustment washer 53, wherein the total thickness of the two adjustment washers 52, 53 corresponds to that of FIG. 6. By this configuration of the adjustment washers 52, 53, the second connecting ring 50 is positioned further towards the first connecting ring 40 if necessary.

The valve needle 15 is preferably moved with the aid of an electromagnet, which is not shown in FIG. 1. The valve needle 15 may also be moved using another electrical actuator, for example a piezoelectric actuator or a magnetostrictive actuator. Servo-hydraulic movement of the valve needle 15 is also possible.

1. A fuel valve for metered delivery of fuel having a housing (1) which can be filled with a fluid fuel and having an outlet opening (7), and a valve needle (15) disposed in the housing (1) which can be moved in a longitudinal direction and which interacts with a valve seat (17) to open and close the outlet opening (7), wherein the valve needle (15) is surrounded for a portion of its length by a crimping bellows (30) which seals an interior internal chamber (32),
wherein
the crimping bellows (30) is connected at an end facing the outlet opening (7) to a connecting ring (40) in a fluid-tight manner, and is tensioned by a tensioning nut (23) surrounding the valve needle (15) against a sealing seat (41) on the valve needle (15).

2. The fuel valve of claim 1, wherein the tensioning nut (23) engages a thread (19) formed on an outer side of the valve needle (15).

3. The fuel valve according to claim 1, wherein in that a tensioning sleeve (21) surrounding the valve needle (15) is disposed between the tensioning nut (23) and the connecting ring (40), wherein the tensioning sleeve transfers a pressing force of the tensioning nut (23) to the connecting ring (40).

4. The fuel valve according to claim 3, wherein in that the valve needle (15) forms an outer contour (49) in an area of the tensioning sleeve (21), and wherein the tensioning sleeve (21) engages in a positive-locking manner so that the tensioning sleeve (21) is secured against rotation about its longitudinal axis.

5. The fuel valve according to claim 1, wherein the sealing seat (41) is conical.

6. The fuel valve according to claim 5, wherein a conical abutment surface (44) is formed on the connecting ring (40) with which the connecting ring (40) rests on the sealing seat (41).

7. The fuel valve according to claim 1, wherein the sealing seat (41) is configured as a flat annular surface and a flat abutting surface (44)′ is configured on the connecting ring (40)′, which also forms an annular surface and with which the connecting ring (40)′ rests on the sealing seat (41).

8. The fuel valve according to claim 1, wherein a sealing ring (48) is disposed between the connecting ring (40) and the nozzle needle (15).

9. The fuel valve according to claim 1, wherein an end of the crimping bellows (30) facing away from the outlet opening (7) is connected to a second connecting ring (50) to form a seal.

10. The fuel valve according to claim 9, wherein the second connecting ring (50) abuts a shoulder (55) facing the outlet opening (7) in the housing (1).

11. The fuel valve according to claim 10, wherein the second connecting ring (50) is tensioned against the shoulder (55) by a tensioning screw (37).

12. The fuel valve according to claim 11, wherein a first adjustment washer (52) and a second adjustment washer (53) are disposed between the second connecting ring (50) and the tensioning screw (37) and/or between the second connecting ring (50) and the shoulder (55).

13. The fuel valve according to claim 1, wherein the internal chamber (32) is filled with a lubricant.
